(19) United States
(12) Patent Application Publication
(10) Pub. No.: US 2014/0145944 A1
(43) Pub. Date: May 29, 2014

(54) Display System

(71) Applicant: Chih-Neng Chang, Taipei City (TW)

(72) Inventor: Chih-Neng Chang, Taipei City (TW)

(21) Appl. No.: 13/684,259

(22) Filed: Nov. 23, 2012

(51) Int. Cl. G06F 3/0487

(52) U.S. Cl. CPC G06F 3/0487
USPC 345/157

(57) ABSTRACT

A display system includes a display panel and a pointing device. The display panel includes plural pixels and a matrix of n×m sensing units, wherein n and m are integers larger than 2. The pointing device emits a light beam to form a light beam spot at a spot location, which is movable on the display panel and controlled by the user, wherein the sensing units sense the spot location.

### TECHNICAL FIELD

The present disclosure relates to a display system, especially to a display system interactively controlled by a user.

### BACKGROUND

The displays, e.g. televisions (TV), have gradually become more important than ever for the human lives. As the technologies continuously advance, the screen size of TV becomes larger and larger with slimmer and slimmer dimensions. On the other hand, the transmission rates of wireless and fiberoptic communications are consecutively growing. Consequently, there is a trend to combine TV programs on a TV and information contents of a computer together into a display so as to provide great convenience to people.

Conventionally, we use the remote controller with numeral and directional (up, down, right and left) buttons to select a channel to watch on a TV. However, the TV programs on TV channels are scheduled and arranged by the supply companies, and the users can not determine their preferred time to watch. In addition, the TV programs to be displayed are limited and determined by the supply companies.

On the other hand, through the internet, we can search the information we need, purchase the required articles and watch the preferred contents by using the mouse and computer to interactively control the interface displayed on the screen of the monitor. However, it is not convenient to use the mouse to control the display in the living room or public room, since the mouse needs to be held by a hand to move on a solid surface, e.g. on a mouse pad or on a desk.

From the above description, it can be known that there is a strong need to develop better technologies for integrating the TV programs and the information contents together into the display to allow better interactive control by the users.

### SUMMARY

In accordance with one aspect of the present disclosure, a display system controlled by a user is provided. The display system includes a display panel and a pointing device. The display panel includes plural pixels and a matrix of n×m sensing units, wherein n and m are integers larger than 2. The pointing device emits a light beam to form a light beam spot at a spot location, which is movable on the display panel and controlled by the user, wherein the sensing units sense the spot location.

In accordance with another aspect of the present disclosure, a display system controlled by a user is provided. The display system includes a display panel and a pointing device. The display panel includes a matrix of n×m display-and-sensing units, each of which includes a pixel and a sensing unit, wherein n and m are integers larger than 2. The pointing device emits a light beam to form a light beam spot at a spot location, which is movable on the display panel and controlled by the user, wherein the sensing units sense the spot location.

In accordance with a further aspect of the present disclosure, a display system controlled by a user is provided. The display system includes a display panel and a pointing device. The display panel has a display area and an edge area surrounding the display area, and includes plural pixels disposed in the display area and plural sensing units disposed in the display area. The pointing device emits a light beam to form a light beam spot at a spot location, which is movable on the display panel and controlled by the user, wherein the plural sensing units sense the spot location.

The above objects and advantages of the present disclosure will become more readily apparent to those ordinarily skilled in the art after reviewing the following detailed descriptions and accompanying drawings, in which:

### BRIEF DESCRIPTION OF THE DRAWINGS

FIG. 1A is the schematic diagram showing a display system in some embodiments of the present disclosure;

FIG. 1B is the schematic diagram showing an enlarged view on the area encircled by the circle A in FIG. 1A in some embodiments of the present disclosure;

FIG. 1C is the schematic diagram showing an enlarged view on the pixels in the display panel in FIG. 1A in some embodiments of the present disclosure;

FIG. 1D is the schematic diagram showing an enlarged view on the pixels in the display panel in FIG. 1A in some embodiments of the present disclosure;

FIG. 1E is the schematic diagram showing an enlarged view on the pixels in the display panel in FIG. 1A in some embodiments of the present disclosure;

FIG. 2 is the schematic diagram showing a pointing device in some embodiments of the present disclosure;

FIG. 3A is the schematic diagram showing a display system in some embodiments of the present disclosure;

FIG. 3B is the schematic diagram showing an enlarged view on the area encircled by the circle B in FIG. 3A in some embodiments of the present disclosure; and

FIG. 3C is the schematic diagram showing an enlarged view on the area encircled by the circle B in FIG. 3A in some embodiments of the present disclosure.

### DETAILED DESCRIPTION

The present invention will be described with respect to particular embodiments and with reference to certain drawings, but the invention is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein. Moreover, the terms top, bottom, over, under and the like in the description and the claims are used for descriptive purposes and not necessarily for describing relative positions.

The present disclosure will now be described more specifically with reference to the following embodiments. It is to be noted that the following descriptions of preferred embodiments of this disclosure are presented herein for the purposes of illustration and description only; it is not intended to be exhaustive or to be limited to the precise form disclosed.

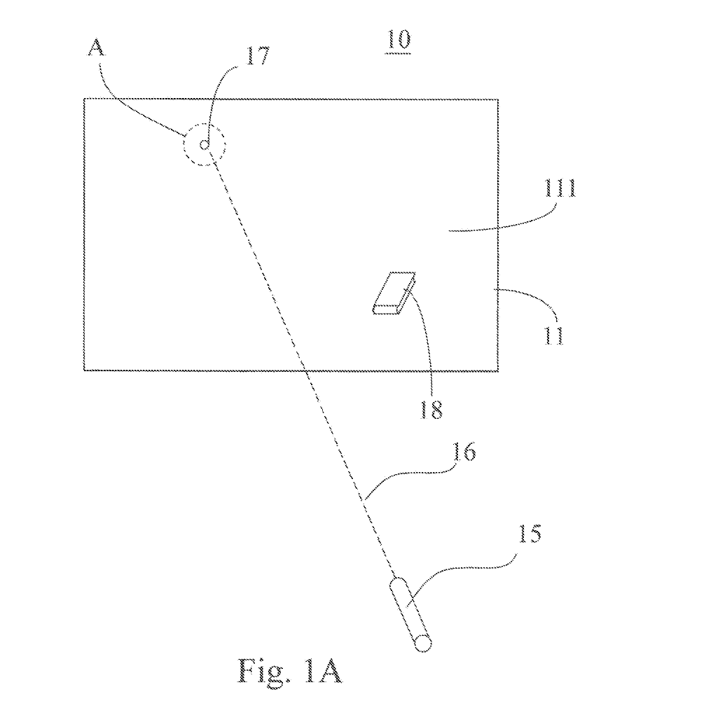

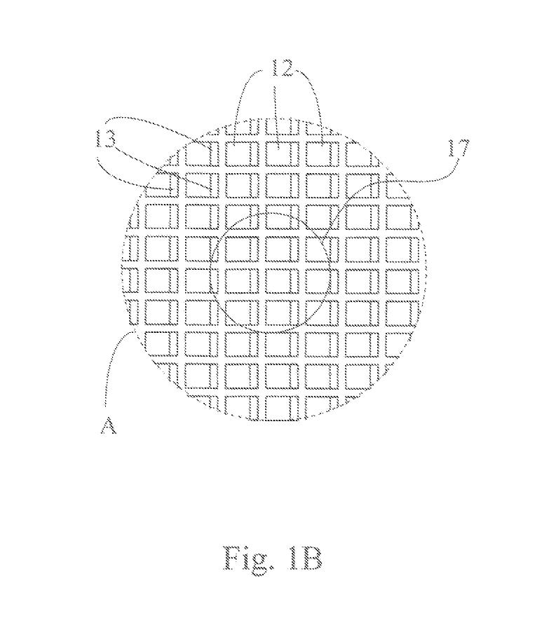

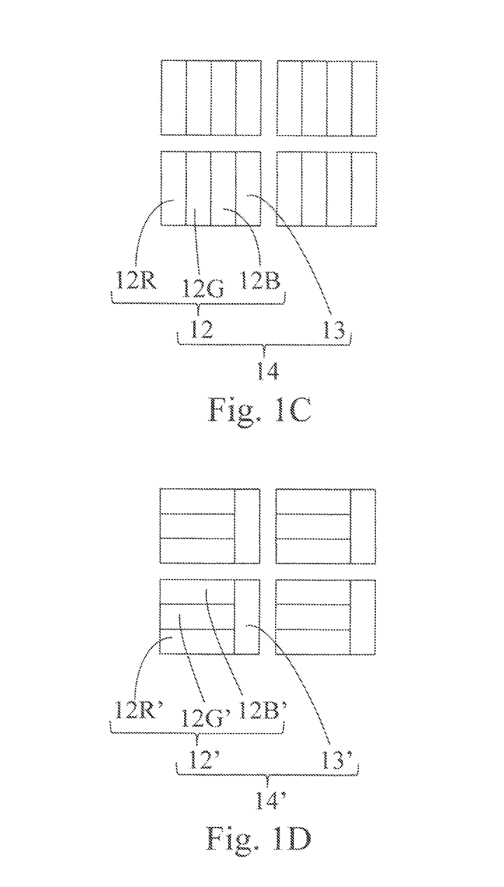

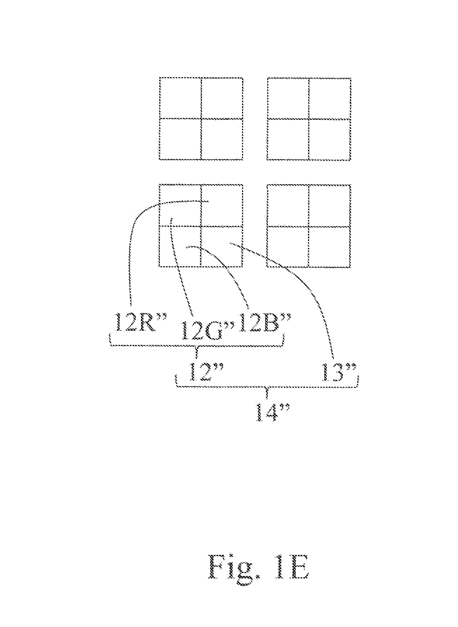

FIG. 1A shows a display system in some embodiments of the present disclosure. A display system 10 includes a display panel 11 and a pointing device 15, as shown in FIG. 1A. The pointing device 15 can emit light beam 16 to form a light beam spot 17 at a spot location, which is movable on the display panel 11 and can be controlled by a user. FIG. 1B shows an enlarged view on the area encircled by the circle A in FIG. 1A in some embodiments of the present disclosure. The display panel 11 contains plural pixels 12 and a matrix of n×m sensing units 13, where n and m are integers larger than 2 and are related to sensing resolutions; while the amount of the pixels 12 are related to displaying resolutions.

Since the matrix of n×m sensing units 13 can well detect the light beam spot location controlled by the user, successful interactions between the display panel 11 and the user can be achieved with great convenience. Although the conventional computer mouse may have the similar interaction, it has to move on a mouse pad or a desk, and accordingly it is not convenient for the user especially in the living room. On the other hand, the conventional TV controller cannot have such interaction, since it is unable to point and indicate the specific location on the display panel. The embodiments shown in FIGS. 1A and 1B in the present disclosure can provide both the great convenience to the user and successful interaction between the display panel and the user just by holding and controlling the pointing device 15 without requiring any inconvenient medium, such as a mouse pad, a desk or a table.

Regarding the displaying resolutions, the display of full high definition (HD), a well-known global standard of display definitions, contains 1920×1080 pixels. Therefore, usually the sizes of these pixels are quite tiny and these pixels cannot be recognized by human eyes at watching distance so as to perform qualified fine pictures.

In the embodiments shown in FIGS. 1A and 1B, sensing units 13 are aligned into an n×m matrix, e.g. 1920×1080, and each of the sensing units 13 is disposed next to a pixel 12. Accordingly, the sensing units 13 can sense the spot location, where those sensing units 13 located within the light beam spot 17 can detect the specific light irradiated by the light beam 16. Since the display panel 11 can be placed in a room with lighting, the specific light irradiated by the light beam 16 had better to have a specific light wavelength range, e.g. 638 nm, 656 nm, 658 nm, 671 nm, etc. for red light lasers; 532 nm, 543 nm, etc. for green light lasers; 473 nm, etc. for blue light laser; and 808 nm, 1064 nm, etc. for infrared laser, and/or enough light intensity above a threshold so as to allow the sensing units 13 to distinguish the light beam of the pointing device 15 from that of the environment.

The pointing device 15 can be a laser pointing device and/or a light emitting diode (LED) pointing device with optical lens and/or prisms to concentrate the light beam. The sensing units 13 can be made of a charge-coupled device (CCD) or a complementary metal-oxide semiconductor (CMOS).

The display panel 11 can include a user interface 111 with an object 18 thereon. The object 18 can be an icon, a photo, a group of texts, etc. to allow a user to select it for activating a software or firmware command thereof, e.g. activating an application program, opening a window of textural information and/or graphical illustration, going to the next/previous page, showing a related video, watching an indicated movie, initiating a voice message, making a video phone call and so on.

The display system 10 can include a processor (not shown) electrically coupled to the sensing units 13, which can send a sensing signal with the information of the spot location 17 to the processor. The processor can be located inside or outside the display panel 11. As the user moves the pointing device 15 for directing the light beam 16 to the display panel 11 in FIG. 1A, the light beam spot 16 moves on the display panel 11. The light beam 16 can have light wavelengths within a visible wavelength range or an infrared wavelength range.

When the light wavelengths of the light beam 16 is within the visible wavelength range, the user can directly see the light beam spot 17 on the display panel 11. In such conditions, when the light beam spot 17 directed and controlled by the user moves to overlap the object 18 on the user interface 111, one of the following two technical schemes can be performed:

(1) The processor generates a cursor signal to show a selectable cursor figure (not shown) overlapping the object for the user to select the object 18 to activate a command thereof; and

(2) The processor generates an object signal for causing the object 18 to show a selectable object figure (not shown) for the user to select the object to activate a command thereof, and otherwise to show a normal object figure shown in FIG. 1A.

In the above technical scheme (1), the selectable cursor figure can be a hand figure as we see in the computer interface, a text block figure, or any other figure to schematically inform the user of the object with a software or firmware command available to be activated.

In the above technical scheme (2), the selectable object figure instead of the selectable cursor figure is shown to inform the user of the object with a software or firmware command available to be activated. The object is shown in the selectable object figure only when the cursor overlaps the object 18, and is shown in the normal object figure when the cursor does not overlap the object 18. The selectable object figure can be obtained by enlarging or brightening the original normal object figure or by adding a text block, changing the color of the original normal object figure or performing other variations.

When the pointing device 15 emits visible light, the shape of the light beam spot 17 is not limited to the circular shape as shown in FIGS. 1A and 1B, but can be shapes of ring, hand, arrow or any other shape by placing a mask or shaped light guide into the pointing device 15. Thus, in addition to the above-mentioned specific light wavelength range and enough light intensity above a threshold for the light beam 16 so as to distinguish the light beam 16 of the pointing device 15 from that of the environment by the sensing units 13, the shape and size range of the light beam spot 17 can be selectively another two factors designed to achieve such distinguishing in the present disclosures.

Furthermore, in addition to the above mentioned emitting parameters of specific light wavelength, light intensity, light beam spot size and light beam spot shape, other emitting parameters, including radiation frequency, pulse frequency, etc., of the light beam 16 can be applied to allow the sensing units 13 to distinguish the light beam 16 of the pointing device 15 from that of the environment as well. To be notable, we only need to choose one or more of these emitting parameters, i.e. specific light wavelength, light intensity above a threshold, light beam spot size and light beam spot shape, radiation frequency, pulse frequency, etc., for distinguishing the light beam 16 of the pointing device 15 from that of the environment.

On the other hand, when the light wavelengths of the light beam 16 is within the infrared wavelength range, e.g. 808 nm, etc. for infrared lasers, the human eyes cannot see the light beam spot 17 on the display panel 11, though the light beam spot 17 does exist there; while the sensing units 13, made of CCD or CMOS, still can detect the infrared light within the light beam spot 17. In such conditions, the sensing units 13 detect the infrared light of the light beam 16 and send the sensing signal with the information of the spot location to the processor, and then the processor can generate a cursor signal to display a cursor (not shown) at the spot location on the user interface. Therefore, the user can clearly recognize the spot location, i.e. the location of the cursor, under the condition that the user cannot see the infrared light beam spot 17. As the infrared light beam spot 17 directed and controlled by the user moves on the display panel 11, the cursor moves on the user interface 111. When the cursor moves to overlap the object 18 on the user interface 111, one of the following two technical schemes can be performed:

(a) The cursor is shown in a selectable cursor figure for the user to select the object to activate a command thereof, and otherwise is shown in a normal cursor figure; and

(b) The object is shown in a selectable object figure for the user to select the object to activate a command thereof, and otherwise is shown in a normal object figure.

In the above technical scheme (a), the cursor is shown in a selectable cursor figure only when the cursor overlaps an object, e.g. the object 18, and is shown in the normal cursor figure when the cursor does not overlap an object, e.g. the object 18. The selectable cursor figure can be a hand figure as we see in the computer interface, a text block figure, or any other figure to schematically inform the user of the object with a software or firmware command available to be activated; while the normal cursor figure can be an arrow figure, a circular figure or any other figure as long as the user can distinguish the selectable cursor figure and the normal cursor figure so as to recognize an available object.

In the above technical scheme (b), the selectable object figure instead of the selectable cursor figure is shown to inform the user of the object with a software or firmware command available to be activated. The object 18 is shown in the selectable object figure only when the cursor overlaps the object 18, and is shown in the normal object figure when the cursor does not overlap the object 18. The selectable object figure can be obtained by enlarging or brightening the original normal object figure or by adding a text block, changing the color of the original normal object figure or performing other variations.

The display panel 11 can be a liquid crystal display (LCD) panel, a light emitting diode (LED) panel, an organic light emitting diode (OLED) panel, a plasma display panel, an electrophoretic display panel or any other pixelized display panel.

For clearly illustrating the structures of the pixels and sensing units, FIG. 1C shows an enlarged view on some pixels on the display panel 11 of FIG. 1A in some embodiments of the present disclosure. As shown in FIG. 1C, each of the pixels 12 contains a red sub-pixel 12R, a green sub-pixel 12G and a blue sub-pixel 12B. The sensing unit 13 and its adjacent pixel 12, including the red sub-pixel 12R, the green sub-pixel 12G and the blue sub-pixel 12B, can together form a display-and-sensing unit 14. That is, the display panel 11 in FIGS. 1A, 1B and 1C can contains a matrix of n×m display-and-sensing units 14, wherein n and m are integers larger than 2, e.g. 1920×1080 for full HD global display standard. Basically, the larger values of n and m depending on practical applications are designed, the higher displaying and sensing resolutions are achieved.

The configurations of each pixel 12 or each display-and-sensing unit 14 are not limited to those shown in FIG. 1C, but can be flexibly varied. For example, FIG. 1D shows an enlarged view on the pixels in the display panel in FIG. 1A in some other embodiments of the present disclosure. In FIG. 1D, each of pixels 12′ includes a red sub-pixel 12R′, a green sub-pixel 12G′ and a blue sub-pixel 12B′, which alignments are perpendicular to those shown in FIG. 1C. A sensing unit 13′ and its adjacent red sub-pixel 12R′, green sub-pixel 12G′ and blue sub-pixel 12B′ can together form a display-and-sensing unit 14′ as shown in FIG. 1D.

FIG. 1E shows an enlarged view on the pixels in the display panel in FIG. 1A in some other embodiments of the present disclosure. In FIG. 1E, each of pixels 12″ includes a red sub-pixel 12R″, a green sub-pixel 12G″ and a blue sub-pixel 12B″. A sensing unit 13″ and its adjacent red sub-pixel 12R″, green sub-pixel 12G″ and blue sub-pixel 12B″ have square shapes, and can together form a display-and-sensing unit 14″ as shown in FIG. 1E. The configurations of each pixel or each display-and-sensing unit shown in FIGS. 1C, 1D and 1E are just some examples for illustrations, and can be flexibly varied based on the inventive concepts of the present disclosures as long as both these pixels and sensing units are evenly distributed all over the display surface of the display panel.

It is notable that the sizes of the pixels 12 and sensing units 13 are shown just for clear illustration only, and may be much smaller than that of the light beam spot 17 in the practical applications.

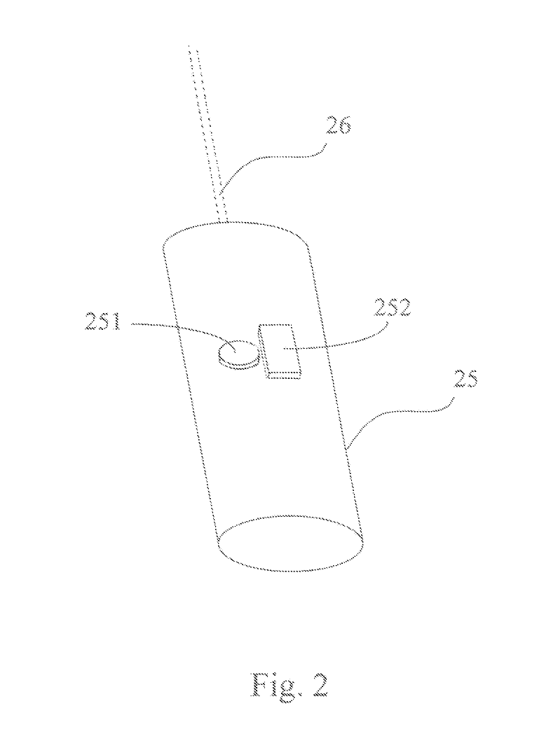

FIG. 2 shows a pointing device in some embodiments of the present disclosure. In FIG. 2, the pointing device 25 includes a control unit 251 for the user to perform at least one control action, including selecting the object 18 on the user interface 111, turning on the display panel 11, turning off the display panel 11, moving to a next page (or a previous page) on the user interface 111, and showing a pop-up menu on the user interface 111. The control unit 251 shown in FIG. 2 is a button to be pressed, but can be a switch, a touch pad, other mechanical structures or even a voice control unit. When the button 251 is pressed, the pointing device 25 emits the light beam 26 with a selection radiation frequency (or pulse frequency) different from the original radiation frequency so that the sensing units 13 can distinguish and send the selection signal to the processor to activate the software or firmware command of the selected object. When the control unit is a voice control unit, it can sense the voice from the user. If the sensed voice matches the predetermined voice, similarly the pointing device 25 will emit the light beam 26 with a selection radiation frequency (or pulse frequency) different from the original radiation frequency so that the sensing units can distinguish and send the selection signal to the processor to activate the software or firmware command of the selected object.

In addition to the above-mentioned different radiation frequencies (or pulse frequencies) as the criteria for the selection of the object, different light intensities, different light wavelengths and so on can be applied instead, based on the present inventive concepts.

Furthermore, the pointing device 25 can optionally include a zoom unit 252, which is a slide plate in FIG. 2, for performing a zoom-in and a zoom-out functions on an image (or picture) centered at the spot location. Certainly, the zoom unit 252 can be designed as a pair of buttons, a switch, a swing plate, a touch pad, other mechanical structures or even a voice control unit rather than the slide plate shown in FIG. 2 based on the present inventive concepts.

Optionally, the pointing device 25 can include more buttons (not shown) for performing the functions of power-on, power-ff, pop-up menu, etc. Alternatively, the button 251 can perform these functions of power-on, power-ff and pop-up menu in addition to the selection function by different actions on the button 251 without more buttons. For instance, when the display panel is powered off, it can be turned on by pressing and holding the button 251 for a predetermined time period or longer, e.g. 2 seconds, and when the display panel is already powered on, it can be turned off by pressing and holding the button 251 for the predetermined time period or longer, e.g. 2 seconds. When the user wants to see the pop-up menu and choose some item therein, he/she can quickly and consecutively presses the button 251 twice to show the pop-up menu on the user interface of the display panel. By performing the above mentioned actions on the button 251, all the functions of selection of the object, power-on of the display panel, power-off of the display panel, appearance of a pop-up menu on the user interface, etc. can be accomplished by using only one button 251.

From the above description, the pointing device 25 provides not only the pointing function but also the controlling functions, including the functions of selection of the object, power-on of the display panel, power-off of the display panel, appearance of a pop-up menu on the user interface, etc. The pointing device 25 can emits the light beam by varying an emitting parameter thereof to perform these controlling functions. The emitting parameter can be a radiation frequency, a pulse frequency, a light intensity, a light wavelength, a light beam spot shape or a light beam spot size. For example, the radiation frequencies of about 0.1, 1, 10, 10 and 100 MHz in the same light wavelength for the emitting light beam can correspond to the functions of pointing, selection, power-on, power-off and pop-up menu, respectively, so the sensing units on the display panel can recognize the corresponding function.

In another example, five different light beam spot shapes provided by the pointing device 25 in the same light wavelength and in the same radiation frequency can correspond to the functions of pointing, selection, power-on, power-off and pop-up menu, respectively, so the sensing units on the display panel can recognize the corresponding function.

Thus, the functions of pointing, selection of the object, power-on of the display panel, power-off of the display panel, showing a pop-up menu on the user interface and selection of an item on the pop-up menu resulting from the technical designs of the display systems in the present disclose can provide excellent and convenient control on the user interface of the display panel by the user's hand moving in the air without any redundant medium, e.g. a mouse pad, a desk or a table. All these technical efficacies and advantages resulting from the display systems in the present disclosure cannot be achieved by the conventional remote controller or computer mouse.

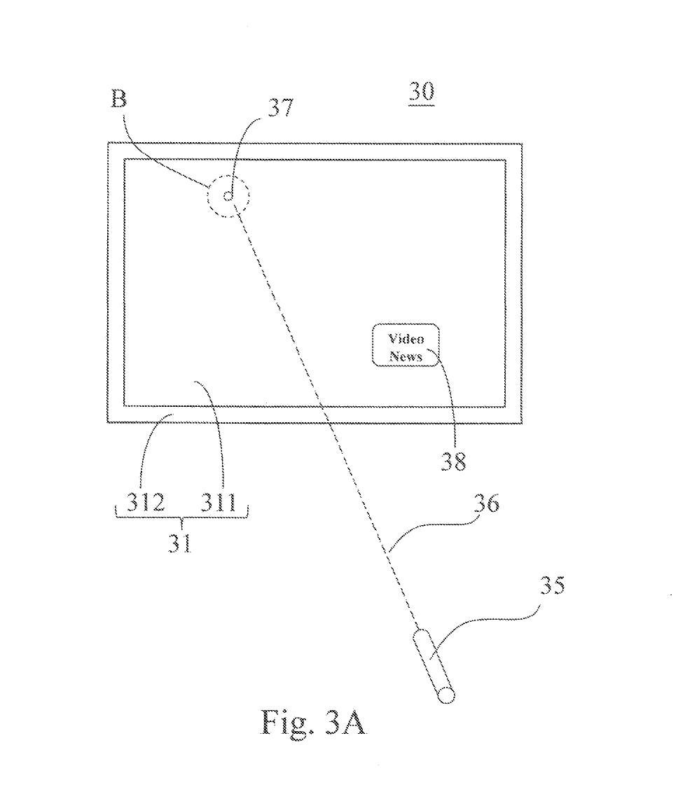

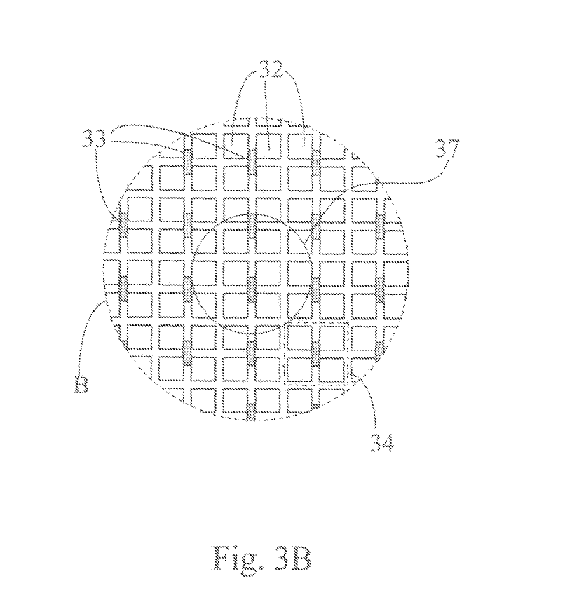

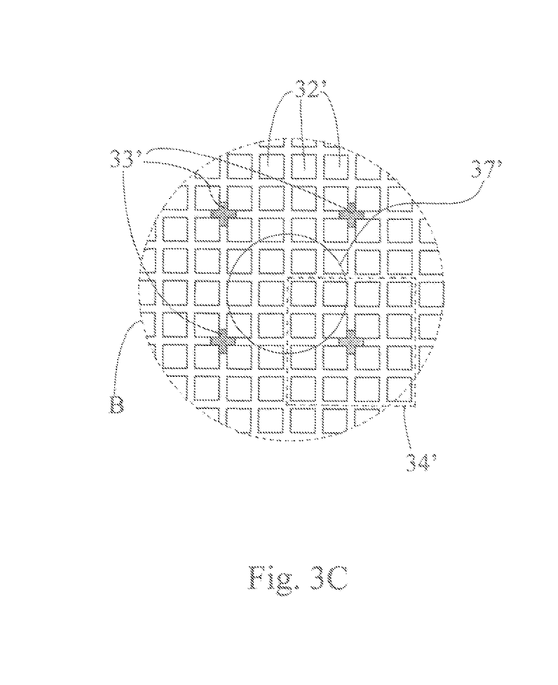

FIG. 3 shows a display system in some embodiments of the present disclosure. As shown in FIG. 3, the display system 30 includes a display panel 31 and a pointing device 35. The display panel 31 has a display area 311 and an edge area 312 on its surface. The edge area 312 surrounds the display area 311. The pointing device 35 directed and controlled by a user can emit a light beam 36 to form a light beam spot 37 at a spot location, which is movable on the display panel 31 and controlled by the user.

Similarly, the display panel 31 can include a user interface, located at the display area 311, with an object 38 thereon. Although shown as a video news in FIG. 3A for an example, the object 38 can be an icon, a photo, a group of texts, etc. to allow a user to select it for activating a software or firmware command thereof, e.g. activating an application program, opening a window of text information and/or graphical illustration, going to the next/previous page, showing a related video, watching an indicated movie, initiating a voice message, making a video phone call and so on.

Similarly, the display panel 31 can be a liquid crystal display (LCD) panel, a light emitting diode (LED) panel, an organic light emitting diode (OLED) panel, a plasma display panel, an electrophoretic display panel or any other pixelized display panel.

The display panel 31 includes plural pixels 32 and plural sensing units 33 as shown in FIG. 3B, which illustrates an enlarged view on the area encircled by the circle B in FIG. 3A in some embodiments of the present disclosure. All the pixels 32 and the sensing units 33 are located in display area 311 rather than in the edge area 312. It can be observed from FIGS. 3A and 3B that each of the sensing units 33 is located at the center of four surrounding pixels 32, and each of display-and-sensing units 34 contains one sensing unit 33 and h pixels, wherein h is an integer equal to 4 in such embodiments. Just for clearly showing the configurations, the sensing units 33 are drawn by being filled with grey color in FIG. 3B. In contrast with those embodiments shown in FIGS. 1A, 1C and 1D, each of the display-and-sensing unit 14 there contains one pixel 12 and one sensing unit 13, so the h is equal to 1. Certainly, the h can be any integer equal to or larger than 1, based on the inventive concept of the present disclosure.

For those embodiments shown in FIGS. 3A and 3B, all the display-and-sensing units 34 are aligned to form an n×m matrix, wherein n and m are integers larger than 2, and each of the display-and-sensing units 34 contains four pixels 32 and one sensing unit 33, so the total amount of the pixels 32 is equal to four times of that of the sensing units 33. For an example of the full HD global display standard, the display panel 31 in FIGS. 3A and 3B can contain 1920×1080 pixels and 960×540 sensing units. Since the resolution of the sensing units is practically unnecessary to be as high as that of the pixels, the amount of sensing units can be smaller than that of the pixels.

Similarly, the pointing device 35 in FIG. 3A can provide not only the pointing function but also the controlling functions, including the functions of selection, power-on, power-ff, pop-up menu, etc. The pointing device 35 can emits the light beam 36 by varying an emitting parameter thereof to perform these controlling functions. The emitting parameter can be a radiation frequency, a pulse frequency, a light intensity, a light wavelength, a light beam spot shape or a light beam spot size. For example, the radiation frequencies of about 0.1, 1, 10, 10, 100 MHz for the emitting light beam correspond to the functions of pointing, selection, power-on, power-off and pop-up menu, respectively, so the sensing units 33 on the display panel 31 can recognize the corresponding function, which can be combined with the spot location detected by the sensing units to provide excellent and convenient control on the user interface of the display system by the user's hand moving in the air. All these technical efficacies resulting from the inventive concepts and technical schemes cannot be achieved by the conventional remote controller or computer mouse.

FIG. 3C shows an enlarged view on the area encircled by the circle B in FIG. 3A in some other embodiments of the present disclosure. In these embodiments shown in FIGS. 3A and 3C, the display panel 31 can contains display-and-sensing units 34′, which are aligned to form an n×m matrix, wherein n and m are integers larger than 2. Each of the display-and-sensing units 34′ shown in FIG. 3C contains h pixels 32′ and one sensing unit 33′, where h is an integer equal to 16 instead of 4 in FIG. 3B. The h value for those embodiments shown in FIGS. 3B and 3C can be flexibly and desirably adjusted for balancing the sensing resolution and complexity of the related sensing circuits in the practical applications. Similarly, the sensing units 33′ are drawn by being filled with grey color in FIG. 3C just for clearly showing the configurations.

It can be observed that the shape of the each sensing unit 33 in FIG. 3B is different from that of the each sensing unit 33′ in FIG. 3C. Basically, the shape of the each sensing unit can be flexibly designed to be any one as long as the sensing unit can detect the light beam from the pointing device at the predetermined location compared with the object location on the user interface.

Similarly, it is notable that the sizes of the pixels 32, 32′ and sensing units 33, 33′ are shown just for clear illustration only, and may be much smaller than that of the light beam spot 37, 37′ in the practical applications.

Similarly, the pointing device 35 in FIG. 3A can be a laser pointing device and/or a light emitting diode (LED) pointing device with optical lens and/or prisms to concentrate the light beam. The sensing units 33 or 33′ can be made of a charge-coupled device (CCD) or a complementary metal-oxide semiconductor (CMOS).

Similarly, the display system 30 in FIG. 3A can include a processor (not shown) electrically coupled to the sensing units 33 or 33′, which can send a sensing signal with the information of the spot location 37 to the processor. The processor can be located inside or outside the display panel 31. As the user moves the pointing device 35 for directing the light beam 36 to the display panel 31 in FIG. 3A, the light beam spot 36 moves on the display panel 31. The light beam 36 can have light wavelengths within a visible wavelength range or an infrared wavelength range. Due to safety and health concerns, ultraviolet light is not recommended to be used in the pointing device of the present disclosure, even though it is theoretically applicable based on the inventive concept of the present disclosure. In addition, any of the pointing devices described in all the above embodiments can be optionally integrated into a mobile (or cellular) phone, a personal digital assistant (PDA), a global positioning system (GPS) device, a video player, a music player, a pen (including a digital pen), a watch, a key, a hard drive, a flash drive, a camera (including a digital camera), a ring, a Swiss army knife, a flashlight or any other electrical, optical or mechanical portable devices.

According to all the above descriptions, the display systems in all the above embodiments can provide excellent interactive control on the user interface of the display panel by using the pointing device held and directed by the user's hand with outstanding convenience, and can bring human beings into a high level life in a world of a fusion of entertainments (movies, shows, video program, etc.), information (computer program contents, internet contents, etc.) and communications (video phone calls, cloud data downloading/uploading). All these outstanding technical efficacies and advantages cannot be achieved by any conventional techniques, such as the computer mouse, the TV controller, etc.

Some embodiments of the present disclosure are described in the followings.

1. A display system controlled by a user includes a display panel and a pointing device. The display panel includes plural pixels and a matrix of n×m sensing units, wherein n and m are integers larger than 2. The pointing device emits a light beam to form a light beam spot at a spot location, which is movable on the display panel and controlled by the user, wherein the sensing units sense the spot location.

2. A display system controlled by a user includes a display panel and a pointing device. The display panel includes a matrix of n×m display-and-sensing units, each of which includes a pixel and a sensing unit, wherein n and m are integers larger than 2. The pointing device emits a light beam to form a light beam spot at a spot location, which is movable on the display panel and controlled by the user, wherein the sensing units sense the spot location.

3. A display system controlled by a user includes a display panel and a pointing device. The display panel has a display area and an edge area surrounding the display area, and includes plural pixels disposed in the display area and plural sensing units disposed in the display area. The pointing device emits a light beam to form a light beam spot at a spot location, which is movable on the display panel and controlled by the user, wherein the plural sensing units sense the spot location.

4. A display system of any of the above embodiments further includes a processor electrically coupled to the sensing units.

5. In a display system of any of the above embodiments, the light beam has a light wavelength within one of a visible wavelength range and an infrared wavelength range.

6. In a display system of any of the above embodiments, the display panel further includes a user interface having an object thereon.

7. In a display system of any of the above embodiments, the sensing units send a sensing signal having an information of the spot location to the processor.

8. In a display system of any of the above embodiments, on a condition that the light wavelength is within the infrared wavelength range, the processor generates a cursor signal to display a cursor at the spot location on the user interface.

9. In a display system of any of the above embodiments, on a condition that the light wavelength is within the infrared wavelength range, the cursor moves on the user interface as the light beam spot directed by the user moves on the display panel.

10. In a display system of any of the above embodiments, on a condition that the light wavelength is within the infrared wavelength range, when the cursor moves to overlap the object on the user interface, one of followings is operated:

the cursor is shown in a selectable cursor figure for the user to select the object to activate a command thereof, and otherwise is shown in a normal cursor figure; and

the processor generates an object signal for causing the object to show a selectable object figure for the user to select the object to activate a command thereof and otherwise to show a normal object figure.

11. In a display system of any of the above embodiments, on a condition that the light wavelength is within the visible wavelength range, when the light beam spot directed by user moves to overlap the object on the user interface, one of followings is operated:

the processor generates a cursor signal to show a selectable cursor figure overlapping the object for the user to select the object to activate a command thereof; and

the processor generates an object signal for causing the object to show a selectable object figure for the user to select the object to activate a command thereof and otherwise to show a normal object figure.

12. In a display system of any of the above embodiments, the pointing device includes a control unit for the user to perform at least one of a control action including one selected from a group consisting of selecting the object, turning on the display panel, turning off the display panel, moving to a next page, moving to a previous page, and showing a pop-up menu on the user interface.

13. In a display system of any of the above embodiments, the control unit includes one selected from a group consisting of a button, a switch, a touch pad, a voice control unit and a combination thereof.

14. In a display system of any of the above embodiments, the pointing device has at least one of an emitting parameter selected from a group consisting of a radiation frequency, a pulse frequency, a light intensity, the light wavelength, a light beam spot size and a light beam spot shape.

15. In a display system of any of the above embodiments, the sensing units distinguish the light beam of the pointing device from that of an environment based on at least one of the emitting parameter.

16. In a display system of any of the above embodiments, when the control unit performs more than one of the control actions, the pointing device emits the light beam at the emitting parameter having respective values corresponding to each of the control actions for enabling the sensing units to distinguish the control actions.

17. In a display system of any of the above embodiments, each of the sensing units includes one of a charge-coupled device and a complementary metal-oxide semiconductor.

18. In a display system of any of the above embodiments, the pointing device includes one selected from a group consisting of a laser pointing device, a light emitting diode pointing device and a combination thereof.

19. In a display system of any of the above embodiments, the pointing device is integrated into one selected from a group consisting of a mobile phone, a personal digital assistant, a global positioning system device, a video player, a music player, a pen, a watch, a key, a hard drive, a flash drive, a camera, a ring, a Swiss army knife, a flashlight and a combination thereof.

20. In a display system of any of the above embodiments, the display panel comprises one selected from a group consisting of a liquid crystal display panel, a light emitting diode panel, an organic light emitting diode panel, a plasma display panel and an electrophoretic display panel.

21. In a display system of any of the above embodiments, the pointing device includes a zoom unit performing a zoom-in and a zoom-out functions on a picture displayed on the display panel and centered at the spot location.

22. In a display system of any of the above embodiments, the zoom unit includes one selected from a group consisting of a button, a switch, a slide plate, a swing plate, a touch pad, a voice control unit and a combination thereof.

23. A display system of any of the above embodiments further includes plural display-and-sensing units, each of which includes h pixel of the plural pixels and one of the sensing units, wherein h is an integer equal to or larger than 1.

24. A display system of any of the above embodiments further includes a matrix of n×m display-and-sensing units.

25. In a display system of any of the above embodiments, each of the plural pixels includes a red sub-pixel emitting red light, a green sub-pixel emitting green light and a blue sub-pixel emitting blue light.

26. In a display system of any of the above embodiments, each of the display-and-sensing units includes the red sub-pixel, the green sub-pixel, the blue sub-pixel and one of the sensing units.

27. A display system of any of the above embodiments further includes a matrix of n×m display-and-sensing units, each of which includes h pixel of the plural pixels and one of the plural sensing units, wherein n and m are integers larger than 2, and h is an integer equal to or larger than 1.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display system controlled by a user, comprising:
a display panel including:
plural pixels; and
a matrix of n×m sensing units, wherein n and m are integers larger than 2; and
a pointing device emitting a light beam to form a light beam spot at a spot location, which is movable on the display panel and controlled by the user, wherein the sensing units sense the spot location.

2. A display system of claim 1, further comprising a processor electrically coupled to the sensing units, wherein:
the light beam has a light wavelength within one of a visible wavelength range and an infrared wavelength range;
the display panel further includes a user interface having an object thereon; and
the sensing units send a sensing signal having an information of the spot location to the processor.

3. A display system of claim 2, wherein on a condition that the light wavelength is within the infrared wavelength range:
the processor generates a cursor signal to display a cursor at the spot location on the user interface;
the cursor moves on the user interface as the light beam spot directed by the user moves on the display panel; and
when the cursor moves to overlap the object on the user interface, one of followings is operated:
the cursor is shown in a selectable cursor figure for the user to select the object to activate a command thereof, and otherwise is shown in a normal cursor figure; and
the processor generates an object signal for causing the object to show a selectable object figure for the user to select the object to activate a command thereof and otherwise to show a normal object figure.

4. A display system of claim 2, wherein on a condition that the light wavelength is within the visible wavelength range:
when the light beam spot directed by user moves to overlap the object on the user interface, one of followings is operated:
the processor generates a cursor signal to show a selectable cursor figure overlapping the object for the user to select the object to activate a command thereof; and
the processor generates an object signal for causing the object to show a selectable object figure for the user to select the object to activate a command thereof and otherwise to show a normal object figure.

5. A display system of claim 2, wherein:
the pointing device includes a control unit for the user to perform at least one of a control action including one selected from a group consisting of selecting the object, turning on the display panel, turning off the display panel, moving to a next page, moving to a previous page, and showing a pop-up menu on the user interface;
the control unit includes one selected from a group consisting of a button, a switch, a touch pad, a voice control unit and a combination thereof;
the pointing device has at least one of an emitting parameter selected from a group consisting of a radiation frequency, a pulse frequency, a light intensity, the light wavelength, a light beam spot size and a light beam spot shape;
the sensing units distinguish the light beam of the pointing device from that of an environment based on at least one of the emitting parameter; and
when the control unit performs more than one of the control actions, the pointing device emits the light beam at the emitting parameter having respective values corresponding to each of the control actions for enabling the sensing units to distinguish the control actions.

6. A display system of claim 1, wherein:
each of the sensing units includes one of a charge-coupled device and a complementary metal-oxide semiconductor;
the pointing device includes one selected from a group consisting of a laser pointing device, a light emitting diode pointing device and a combination thereof; and
the pointing device is integrated into one selected from a group consisting of a mobile phone, a personal digital assistant, a global positioning system device, a video player, a music player, a pen, a watch, a key, a hard drive, a flash drive, a camera, a ring, a Swiss army knife, a flashlight and a combination thereof.

7. A display system of claim 1, wherein:
the display panel comprises one selected from a group consisting of a liquid crystal display panel, a light emitting diode panel, an organic light emitting diode panel, a plasma display panel and an electrophoretic display panel;
the pointing device comprises a zoom unit performing a zoom-in and a zoom-out functions on a picture displayed on the display panel and centered at the spot location; and
the zoom unit includes one selected from a group consisting of a button, a switch, a slide plate, a swing plate, a touch pad, a voice control unit and a combination thereof.

8. A display system of claim 1, further comprising plural display-and-sensing units, each of which includes h pixel of the plural pixels and one of the sensing units, wherein h is an integer equal to or larger than 1.

9. A display system of claim 1, further comprising a matrix of n×m display-and-sensing units, wherein:
each of the plural pixels includes a red sub-pixel emitting red light, a green sub-pixel emitting green light and a blue sub-pixel emitting blue light; and
each of the display-and-sensing units includes the red sub-pixel, the green sub-pixel, the blue sub-pixel and one of the sensing units.

10. A display system controlled by a user, comprising:
a display panel including:
a matrix of n×m display-and-sensing units, each of which includes a pixel and a sensing unit, wherein n and m are integers larger than 2; and
a pointing device emitting a light beam to form a light beam spot at a spot location, which is movable on the display panel and controlled by the user, wherein the sensing units sense the spot location.

11. A display system of claim 10, further comprising a processor electrically coupled to the sensing units, wherein:
the light beam has a light wavelength within one of a visible wavelength range and an infrared wavelength range;
the display panel further includes a user interface having an object thereon; and
the sensing units send a sensing signal having an information of the spot location to the processor.

12. A display system of claim 11, wherein on a condition that the light wavelength is within the infrared wavelength range:
the processor generates a cursor signal to display a cursor at the spot location on the user interface;
the cursor moves on the user interface as the light beam spot directed by the user moves on the display panel; and
when the cursor moves to overlap the object on the user interface, one of followings is operated:
the cursor is shown in a selectable cursor figure for the user to select the object to activate a command thereof, and otherwise is shown in a normal cursor figure; and
the processor generates an object signal for causing the object to show a selectable object figure for the user to select the object to activate a command thereof and otherwise to show a normal object figure.

13. A display system of claim 11, wherein on a condition that the light wavelength is within the visible wavelength range:
when the light beam spot directed by user moves to overlap the object on the user interface, one of followings is operated:
the processor generates a cursor signal to show a selectable cursor figure overlapping the object for the user to select the object to activate a command thereof; and
the processor generates an object signal for causing the object to show a selectable object figure for the user to select the object to activate a command thereof and otherwise to show a normal object figure.

14. A display system of claim 11, wherein:
the pointing device includes a control unit for the user to perform at least one of a control action including one selected from a group consisting of selecting the object, turning on the display panel, turning off the display panel, moving to a next page, moving to a previous page, and showing a pop-up menu on the user interface;
the control unit includes one selected from a group consisting of a button, a switch, a touch pad, a voice control unit and a combination thereof;
the pointing device has an emitting parameter including one selected from a group consisting of a radiation frequency, a pulse frequency, a light intensity, the light wavelength, a light beam spot size and a light beam spot shape;
the sensing units distinguish the light beam of the pointing device from that of an environment based on at least one of the emitting parameter; and
when the control unit performs more than one of the control actions, the pointing device emits the light beam at the emitting parameter having respective values corresponding to each of the control actions for enabling the sensing units to distinguish the control actions.

15. A display system of claim 10, wherein:
each of the sensing unit includes one of a charge-coupled device and a complementary metal-oxide semiconductor;
the pointing device includes one selected from a group consisting of a laser pointing device, a light emitting diode pointing device and a combination thereof; and
the pointing device is integrated into one selected from a group consisting of a mobile phone, a personal digital assistant, a global positioning system device, a video player, a music player, a pen, a watch, a key, a hard drive, a flash drive, a camera, a ring, a Swiss army knife, a flashlight and a combination thereof.

16. A display system of claim 10, wherein:
the display panel comprises one selected from a group consisting of a liquid crystal display panel, a light emitting diode panel, an organic light emitting diode panel, a plasma display panel and an electrophoretic display panel;
the pointing device comprises a zoom unit performing a zoom-in and a zoom-out functions on a picture displayed on the display panel and centered at the spot location; and
the zoom unit includes one selected from a group consisting of a button, a switch, a slide plate, a swing plate, a touch pad, a voice control unit and a combination thereof.

17. A display system controlled by a user, comprising:
a display panel having a display area and an edge area surrounding the display area, and including:
plural pixels disposed in the display area; and
plural sensing units disposed in the display area; and
a pointing device emitting a light beam to form a light beam spot at a spot location, which is movable on the display panel and controlled by the user, wherein the plural sensing units sense the spot location.

18. A display system of claim 17, further comprising a processor electrically coupled to the sensing units, wherein:
the display panel further includes a user interface having an object thereon;
the sensing units send a sensing signal having an information of the spot location to the processor;
the pointing device includes a control unit for the user to perform at least one of a control action including one selected from a group consisting of selecting the object, turning on the display panel, turning off the display panel, moving to a next page, moving to a previous page, and showing a pop-up menu on the user interface;
the control unit includes one selected from a group consisting of a button, a switch, a touch pad, a voice control unit and a combination thereof;
the pointing device has an emitting parameter including one selected from a group consisting of a radiation frequency, a pulse frequency, a light intensity, a light wavelength, a light beam spot size and a light beam spot shape;
the sensing units distinguish the light beam of the pointing device from that of an environment based on at least one of the emitting parameter;
when the control unit performs more than one of the control actions, the pointing device emits the light beam at the emitting parameter having respective values corresponding to each of the control actions for enabling the sensing units to distinguish the control actions; and
each of the plural sensing units includes one of a charge-coupled device and a complementary metal-oxide semiconductor.

19. A display system of claim 17, wherein:
the pointing device comprises one selected from a group consisting of a laser pointing device, a light emitting diode pointing device and a combination thereof;
the pointing device is integrated into one selected from a group consisting of a mobile phone, a personal digital assistant, a global positioning system device, a video player, a music player, a pen, a watch, a key, a hard drive, a flash drive, a camera, a ring, a Swiss army knife, a flashlight and a combination thereof; and
the display panel comprises one selected from a group consisting of a liquid crystal display panel, a light emitting diode panel, an organic light emitting diode panel, a plasma display panel and an electrophoretic display panel.

20. A display system of claim 17, further comprising a matrix of n×m display-and-sensing units, each of which includes h pixel of the plural pixels and one of the plural sensing units, wherein:
n and m are integers larger than 2;
h is an integer equal to or larger than 1;
the pointing device includes a zoom unit performing a zoom-in and a zoom-out functions on a picture displayed on the display panel and centered at the spot location; and
the zoom unit includes one selected from a group consisting of a button, a switch, a slide plate, a swing plate, a touch pad, a voice control unit and a combination thereof.
